(19) United States
(12) Patent Application Publication
(10) Pub. No.: US 2014/0250200 A1
(43) Pub. Date: Sep. 4, 2014

(54) USING BIOSENSORS FOR SHARING EMOTIONS VIA A DATA NETWORK SERVICE

(71) Applicant: KONINKLIJKE PHILIPS N.V., EINDHOVEN (NL)

(72) Inventors: Lucas Jacobus Franciscus Geurts, Best (NL); Remco Timmer, Utrecht (NL); Tjadde Rutgher Brouwer, Laren (NL); Theodorus Gerardus Hugo Cornelius Raaijmakers, Amsterdam (NL); Wendelina Elise Corinne Loopik, Utrect (NL)

(73) Assignee: KONINKLIJKE PHILIPS N.V., EINDHOVEN (NL)

(21) Appl. No.: 14/349,505

(22) PCT Filed: Nov. 7, 2012
(86) PCT No.: PCT/IB2012/056219

§ 371 Date: Apr. 3, 2014

Related U.S. Application Data
(60) Provisional application No. 61/557,537, filed on Nov. 9, 2011.

(51) Int. Cl. H04L 12/58

(52) U.S. Cl. CPC H04L 51/10
USPC 709/206

(57) ABSTRACT

Mobile electronic communication devices upload input data to a server via a data network. The data uploaded per device is indicative of a physiological or emotional state of the device's user, and of the user's geographical location. The server generates output data per individual user under combined control of the emotional state and geographic location of the individual user. The output data associated with multiple users is rendered as graphical symbols at one or more display monitors, thus being indicative of the geographical distribution of emotions of the population of users.

### FIELD OF THE INVENTION

The invention relates to a method of providing a service via a data network, to a mobile electronic communication device comprising a network-interface, a user-interface, and a sensor-interface, and to control software configured for being installed on such a mobile electronic communication device.

### BACKGROUND ART

The Internet has enabled people to find individuals complying with a certain pre-determined profile much more quickly than before the advent of the Internet. For example, virtual communities have come to the foreground wherein people share their knowledge, feelings or opinions via the Internet. The expression “virtual community” refers to a social network of individuals who interact via specific media such as chat rooms, social networking websites, message boards, microblogs, websites posting customer-satisfaction ratings of enterprises, virtual worlds, massive multi-player gaming, etc. The expression “social network” refers to a group of individuals that forms a social structure based on interdependences, or commonalties, between the individuals. Examples of such interdependencies or commonalties are friendship, kinship, shared interests, shared beliefs, attending the same event, etc. The term “blog” is a blend of the expression “web log” and refers to a type of website, which is maintained by an individual and at which the individual posts updates from time to time in the form of commentary, descriptions of events, or other material such as graphics or video. The term “microblog” refers to a blog featuring very short postings.

An example of a community service provided on the Internet is described in US patent application publication 20050004923, entitled “Community service providing system and method”, filed for Hyuncheol Park, and incorporated herein by reference. The Abstract of US patent application publication 20050004923 refers to a system and method for providing community services wherein emotions or conditions of respective communication service users can be indirectly confirmed by representing information on the emotions or conditions of predetermined communication service users as coordinate values on an emotion map configured on the basis of predetermined information axes and generating predetermined events in accordance with determination results of similarities or differences between the coordinate values based on the coordinate values represented on the emotion map, and thus, opportunities to meet other community members can also be provided through the generation of suitable events. For clarity, the feature “emotion map” as used in the description of US patent application publication 20050004923, refers to an abstract space spanned by multiple axes. Each respective one of the multiple axes refers to a particular emotion or mood. If a user selects a particular position on the map, this particular position is characterized by a set of coordinate values, each respective coordinate value being representative of an intensity of a respective mood.

For completeness, reference is made to the fields of remote physiological monitoring and of affective computing.

The field of remote physiological monitoring relates to the remote sensing of a person's vital signs. Remote physiological monitoring is used in, e.g., the field of biotelemetry, also referred to as medical telemetry. Biotelemetry involves the application of telemetry in the medical field to remotely monitor various vital signs of ambulatory patients. Remote physiological monitoring is also used in, e.g., sports and training programs. Remote physiological monitoring is further used in hazardous environments to check if someone has fallen over (e.g., firefighters, police officers, military personnel) so as to start a search and rescue operation if and when needed.

In the field of affective computing, it is known to use physiological monitoring in order to detect a person's emotional state by means of monitoring and analyzing the person's physiological parameters. The expression “affective computing” refers to the field of systems and devices that can recognize, interpret, process, and simulate human feeling or emotion. Affective computing is an interdisciplinary field spanning computer science, psychology, physiology and cognitive science.

### SUMMARY OF THE INVENTION

The inventors have recognized that, generally, people are motivated to share their emotions with one or more others. One possible reason for this is that an individual likes to have others serve as a sounding board so as to find support when dealing with stressful or worrisome events or circumstances in his/her live. Another reason is that an individual as a member of a virtual community is looking for soul mates, emotional connections or inspiration in other people's responses to his/her emotions in order to make decisions.

Therefore, the inventors propose a service on a data network, e.g., the Internet, to enable a person to share his/her emotions with one or more specific other individuals and/or to contribute (preferably anonymously) to creating a geographical map of occurrences of emotions of people attending a public event in a geographical area.

More specifically, the inventors propose a method of providing a service on a data network. The method comprises receiving via the data network respective input data from a respective one of multiple mobile electronic communication devices of a respective one of multiple users. Each respective mobile electronic communication device comprises a respective sensor and a respective user-interface. The respective sensor is configured for sensing a respective value of a respective physiological parameter indicative of a respective physiological state of the respective user. The respective user-interface is configured for letting the respective user enter into the respective mobile electronic communication device a respective annotation about the respective physiological state. The respective input data comprises respective physiological data representative of the respective value of the respective physiological parameter. The respective input data also comprises respective annotation data representative of the respective annotation. The method further comprises: processing the respective input data for determining a respective emotional state of the respective user; determining a respective geographical location of the respective mobile electronic communication device; and generating respective output data under combined control of the respective emotional state and of the respective geographical location.

Accordingly, the service generates specific output data that is indicative of the emotional state of the user of a specific mobile electronic communication device, as well as of the geographical location of this user. As a result, the specific output data can be mapped onto a geographical map of an environment of the user, and the geographical map can be made accessible to, for example, one or more individuals in the same environment. The combination of emotional state and geographical location of a specific user may then serve to attract others to the same geographical location or, on the contrary, to avoid this geographical location.

Within the context of the current invention, examples of a physiological parameter are: a heart rate or pulse rate of the user, blood pressure, galvanic skin response, body temperature, skin temperature, heat flow, respiration rate, etc. In the fields of biotelemetry and of remote physiological monitoring, sensors are used that are configured for sensing such a physiological parameter and for producing an output signal representative of the value of the physiological parameter sensed. Often, this type of sensor is being referred to as a “biosensor”.

The respective geographical location of the respective user may be determined on the basis of a navigational aid, e.g., a GPS-receiver, accommodated at the respective mobile electronic communication device. Geographical data indicative of the respective geographical location of the respective user is then included into the respective input data. Alternatively, the change of geographical location of each respective user or of each respective mobile electronic communication device is being tracked by a monitoring system external to the respective mobile electronic communication device. For example, a combination of a closed-circuit TV (CCTV) monitoring system and computer-controlled identification is used to track each individual one of the users while residing within a specific geographical area. Alternatively, each respective mobile electronic communication device transmits a respective signal on the basis of which external receivers can determine the respective geographical location of the respective user by means of, e.g., triangulation or proximity to a particular receiver.

In the invention, the sensing of a value of a physiological parameter by the sensor at the mobile electronic communication device, and the communicating of the input data from the mobile electronic communication device to a receiver on the data network, e.g., a server on the Internet, can be carried out on an ongoing basis. That is, the service receives from each particular mobile electronic communication device the input data, associated with the user of the particular mobile electronic communication, in a sequence. Each input data received at a particular certain moment comprises one, or both, of the physiological data and the annotation data applicable to the particular moment. Each particular mobile electronic communication device may have been configured for automatically uploading the physiological data as input data to the pre-determined address on the data network, e.g., under control of a clock or upon the mobile electronic communication device detecting a change in the physiological state of the user. Each particular mobile electronic communication device may have been configured for automatically uploading the annotation data as input data to the data network upon detecting the user-input in the form of the annotation. Carrying out these operations on an ongoing basis enables the receiver to accumulate the physiological data and the annotation data over time and to track changes in the emotional state and in the geographic location of the user of the mobile electronic communication device.

As specified above, the user-interface of the mobile electronic communication device is configured for letting the user enter into the mobile electronic communication device an annotation about the (current) physiological state of the user. Within this context it is remarked that determining the emotional state of a person is difficult if only the values of the physiological parameter(s) are considered that is/are indicative of the physiological state of this person. Typically, the values of the physiological parameters indicate an intensity of an emotion, but not necessarily the valence of the emotion. The expression “valence of an emotion” is used in the field of psychology to characterize types of emotions. Examples of an emotion with a positive valence are happiness, contentment, kindness, etc. Examples of an emotion with a negative valence are anger, fear, irritation, sadness. See, e.g., “Emotion recognition system using short-term monitoring of physiological signals”, K. H. Kim et al., Med. Biol. Eng. Comput., 2004, 42, pp 419-427; or “A User-Modeling Approach to Build User's Psycho-Physiological Maps of Emotions using Bio-Sensors”, Olivier Villon et al., Proc. IEEE RO-MAN 2006, The 15th IEEE International Symposium on Robot and Human Interactive Communication, Hatfield, U.K., Sep. 8, 2006, pp 269-276, IEEE.

The mobile electronic communication device is, for example, a dedicated device designed solely for the sensing of the values of one or more physiological parameters and for the communication of the input data to the data network. Alternatively, the mobile electronic communication device comprises, e.g., a Smartphone or another trusted personal electronic communication device, connected to, or accommodating, a dedicated sensor of the type described above.

An embodiment of the method of the invention comprises transmitting the respective output data for each respective one of the users to a uniform pre-determined address on the data network. The term “uniform” is used to indicate that the pre-determined network address is the same for each of the users of the mobile electronic communication devices.

For example, consider a group-event or a public event that is being held in a specific geographical area. The uniform pre-determined address is the network address of a display monitor system that has one or more display monitors local to the event and viewable by the members of the public attending the event. The display monitor system is configured for rendering the respective output data as respective graphics symbols on one or more display monitor screens. A color, shading or shape of the respective graphics symbol indicates the current emotional state of the user of the respective mobile electronic communication device, whereas a position of the respective graphics symbol on the screen is indicative of this user's current geographical location. Accordingly, in case the screen presents at each moment an adequately large number of graphics symbols, the public can see at one glance where within the geographical area what kinds of emotions are currently being triggered. A clustering of similar emotions within a certain part of the screen may then serve as a recommendation for others to go visit the geographic section of the geographic area corresponding with the part on the screen.

As another example, consider again a group-event or a public event that is being held in a specific geographical area. The uniform pre-determined address is the network address of the data processing system of the organizer of the event. The data processing system has a display monitor for rendering the respective output data as respective graphics symbols on a display monitor screen. The organizer can therefore see at one glance where within the geographical area what kinds of emotions are currently being triggered. The organizer can use this information for example, to plan whether or not, and if so, when and where, to have a specific one of multiple pre-determined acts being performed next. Alternatively, the organizer may be able to detect the first signs of trouble arising when an (unusual) increase occurs in the spatial density, in a part of the screen, of graphics symbols representing emotions with negative valence.

An embodiment of a method of the invention comprises transmitting, to a specific one of the multiple mobile electronic communication devices of a specific one of the users, the respective output data that has been generated from the respective input data received from the respective multiple mobile electronic communication device of each respective other one of the users.

Accordingly, each specific user receives at his/her own mobile electronic communication device the respective output data associated with each respective other one of the users. The mobile electronic communication device is assumed to have a graphical user-interface with a display monitor, and is assumed to have been configured for rendering on the display monitor the output data received. This then enables this specific user to see on the display monitor of his/her own mobile electronic communication device the emotional states and geographic locations of the other users. This then may serve as a recommendation to this specific user to go visit another geographical section than the one wherein he/she is currently present, or to avoid visiting a specific geographic section.

A further embodiment of the method in the invention comprises determining, for each specific one of the multiple users, a specific user-profile; and transmitting, to a specific one of the multiple mobile electronic communication devices of a specific one of the users, the respective output data, generated from the respective input data received from the respective multiple mobile electronic communication device of each respective other one of the users, who has a respective user-profile matching the specific user-profile.

In above embodiment, the mobile electronic communication device of this specific user will only receive the output data associated with those ones among the users, who have a user-profile similar to the user-profile of this specific user. The output data received by each particular user may then even better serve as recommendation than if the output data were received associated with the whole population of users. For example, the user-profile comprises a demographic profile taking into account any one or more of, age, gender, profession, ethnicity, nationality, social class, place of residence, etc. As another example, each user has registered in advance with an organizer of a performing arts event, and has indicated his/her preferences with regard to genre, performing actors, etc. As yet another example, the organizer has prepared in advance a set of pre-determined user-profiles, from which each user can choose the one that fits his/her own personality best.

Another embodiment of the method of the invention comprises: enabling a particular one of the users to specify in advance one or more particular destination addresses on the data network; determining whether or not the particular user has specified the one or more particular destination addresses; and only if the particular user has specified in advance the one or more particular destination addresses, sending the output data, generated under combined control of the emotional state of the particular user and of the geographical location of the particular user, to the one or more particular destination addresses.

For example, the particular user has specified in advance that the output data, generated on the basis of the input data submitted by the mobile electronic communication device of this particular user, be sent to a first particular destination address, to a second particular destination address and to a third particular destination address. The first particular destination address is a network address of his/her own computer at home or of his/her microblog running on a server. In this manner, the service enables this particular user to keep a history log, or diary, of emotional annotations and of a temporal evolution of his/her emotions. The second particular destination address is a network address of data communication equipment (e.g., a home PC, a mobile phone) of a friend and the third destination address is another network address of other data communication equipment of another friend. The friends of this particular user are thus being kept informed about the mood of this particular user while this user is away.

In a further embodiment of the method of the invention, the particular user has specified in advance as the particular destination address a specific address on the data network of a specific one of the multiple mobile electronic communication devices.

Accordingly, information about the emotional state and geographical location of the particular user and the changes of the emotional state and geographic location are communicated to one or more specific ones of the multiple mobile electronic communication devices. For example, the information is sent to the particular mobile electronic communication device of the particular user him/herself, e.g., for keeping a local history log. As another example, the information is sent to one or more other mobile electronic communication devices of his/her buddies. In the latter case, the notifications about the emotional state and evolution thereof may serve as a recommendation to this user's buddies for teaming up.

For completeness, the output data generated from the input data received from a particular one of the mobile electronic communication devices may be sent to the pre-determined network address that is uniform to all mobile electronic communication devices, as well as to one or more pre-determined destination addresses as specified in advance by the user of the particular mobile electronic communication device.

A further embodiment of the method of the invention comprises processing the respective output data only if the respective emotional state complies with a pre-determined criterion.

For example, the pre-determined criterion specifies that the valence have a pre-determined polarity, e.g., positive. Alternatively, the pre-determined criterion specifies that the respective emotional state belong to a majority of the emotional states registered for those users who are present within a certain geographical section. Consider an example application scenario, wherein a display monitor screen shows to the public, attending an event, the emotional states of the users of the mobile electronic communication devices and their geographical distribution within the geographical area covered by the event. The organizer of the event may decide only to show the graphics symbols of those users who are currently experiencing a positive emotion. Alternatively, the organizer may decide to only show per geographical section of the geographical area the graphics symbols of those users whose emotional states match the particular emotional state of the majority of the users within that same geographical section.

As discussed in this text and as illustrated by some examples, the input data is uploaded by the mobile electronic communication device in the invention and is received by, e.g., a server of the provider of the service according to the invention. The input data includes physiological data, annotation data and optionally geographical data. For clarity it is remarked here that the input data forms a temporal sequence of data items. Each specific data item that is uploaded comprises one or more of: 1) physiological data representative of the specific value assumed by a physiological parameter at a moment just preceding the moment of uploading of the specific data item, 2) annotation data representative of a specific annotation entered by the user at a moment just preceding the moment of uploading of the specific data item and 3) depending on whether or not the mobile electronic communication device has a navigational aid, geographic data representative of the specific geographic location of the mobile electronic communication device at a moment just preceding the moment of uploading of the specific data item.

The invention also relates to a mobile electronic communication device comprising a network-interface, a user-interface, and a sensor-interface. The network-interface is configured for data communication between the mobile electronic communication device and a data network. The sensor-interface is configured for receiving a signal from a sensor that is operative to sense a value of a physiological parameter indicative of a physiological state of a user of the mobile electronic communication device. The user-interface is configured for letting the user enter an annotation about the physiological state into the mobile electronic communication device. The mobile electronic communication device is configured for communicating input data to a pre-determined address on the data network. The input data comprises physiological data representative of the value of the respective physiological parameter, and annotation data representative of the annotation.

An embodiment of the mobile electronic communication device is configured for automatically, i.e., without intervention of the user, uploading the physiological data as input data to the pre-determined address on the data network upon the mobile electronic communication device detecting a change in the physiological state of the user. For example, the range of values of the physiological parameter is divided into two or more sub-ranges. Whenever the value of the physiological parameter changes from one range to another range, the physiological data is uploaded as the input data. In this approach, the physiological state of the user is considered as unaltered in the time interval between a pair of subsequent moments at which the value changes ranges. So long as the physiological state does not change, it is unnecessary to upload the physiological data. This approach saves power and processing time at the mobile electronic communication device, and processing bandwidth at the receiver associated with the pre-determined address on the data network.

In an embodiment of the mobile electronic communication device, the user-interface comprises a graphical user-interface for presenting a menu of one or more pre-determined user-selectable options. Each specific one of the one or more pre-determined user-selectable options is indicative of a specific one of one or more possible emotional states of the user. The user-interface enables the user to enter the annotation about the physiological state into the mobile electronic communication device by means of the user selecting a particular one of the one or more user-selectable options in the graphical user-interface.

This embodiment uses a pre-configured menu with graphical symbols representative of possible annotations so that the user is enabled to enter the annotation in a user-friendly and speedy manner.

For example, each specific user-selectable option in the menu is represented in the graphical user-interface as a specific graphical symbol that semantically conveys to the user a specific emotion. The graphical symbols are may have been programmed into the mobile electronic communication device, e.g., by the manufacturer and are fixed. Alternatively, graphical symbols are programmable or re-programmable by the user of the mobile electronic communication device. For example, a web service may offer a variety of graphical symbols, from which the user can select a personal set that the user then can download into his/her mobile electronic communication device. As another example, the user him/herself may design the graphical symbols, or download suitable graphical symbols from the web, and install the graphical symbols at the mobile electronic communication device for use in the menu.

An embodiment of the mobile electronic communication device comprises a navigational aid configured for determining a geographic location of the mobile electronic communication device. The input data comprises geographical data representative of the geographic location of the mobile electronic communication device.

Accordingly, the mobile electronic communication device of this embodiment uploads the geographical data to the pre-determined address so as to enable the receiver to determine the geographic location of the mobile electronic communication device. The mobile electronic communication device may have been configured to only upload the geographical data upon the mobile electronic communication device detecting a change in geographical location according to a pre-determined criterion. For example, so long the mobile electronic communication device remains within a pre-determined section of a geographical area, the mobile electronic communication device does not upload the geographical data. As soon as the position of the mobile electronic communication device moves from one pre-determined section to another pre-determined section, the mobile electronic communication device uploads the geographical data. As another example, the mobile electronic communication device uploads a sequence of geographical data under control of a clock. Geographical data uploaded at a certain moment is then representative of a geographical location of the mobile electronic communication device at that moment. As yet another example, the mobile electronic communication device is configured for uploading the geographic data under control of a magnitude of a change of the geographical location per unit time. When the mobile electronic communication device and, therefore, the user, are moving swiftly, the mobile electronic communication device uploads successive geographical data more often than if the mobile electronic communication device moves slowly or remains at the same geographical location. In this manner, the geographical position of the mobile electronic communication device, as derived from the geographical data at the receiver, remains accurate without the need for continuously receiving and processing geographic data at the receiver.

The invention also relates to control software configured for being installed on a mobile electronic communication device with a network-interface, a sensor-interface and a user-interface. The network-interface is configured for data communication between the mobile electronic communication device and a data network. The sensor-interface is configured for receiving a sensor signal from a sensor. The sensor is operative to sense a value of a physiological parameter indicative of a physiological state of a user of the mobile electronic communication device. The user-interface is configured for enabling the user to interact with the mobile electronic communication device. The control software comprises: first instructions for processing the sensor signal for generating physiological data representative of the value of the physiological parameter; second instructions for receiving from the user-interface annotation data that is representative of an annotation entered by the user into the mobile electronic communication device via the user-interface; third instructions for generating input data that comprises the physiological data and the annotation data; and fourth instructions for transmitting the input data via the data network to one or more pre-determined destinations on the data network.

The control software may be provided as stored on a computer readable medium, e.g., a magnetic disk, and optical disc, a solid-state memory, etc., or may be provided as an electronic file for being downloaded via the Internet or another data network.

The mobile electronic communication device has been specified as being equipped with a network-interface, a sensor-interface and a user-interface. Such a device may be embodied by a palmtop PC, a Smartphone or another mobile telephone. Installing the software on such a device and hooking up a suitable sensor prepares the device for functioning as described above with reference to the mobile electronic communication device. As almost everyone nowadays has a mobile telephone, the control software and a suitable sensor are all that is needed to implement the invention in the embodiment of the mobile electronic communication device as specified above.

In an embodiment of the control software, the control software comprises fifth instructions for detecting a change in the physiological state of the user, and the fourth instructions comprise sixth instructions for automatically uploading the physiological data in the input data to the pre-determined address on the data network upon the detected change in the physiological state of the user.

In an embodiment of the control software, the user-interface comprises a graphical user-interface. The control software comprises seventh instructions for presenting a menu of one or more pre-determined user-selectable options. Each specific one of the one or more pre-determined user-selectable options is indicative of a specific one of one or more possible emotional states of the user. The control software comprises eighth instructions for generating the annotation data in response to the user selecting a particular one of the one or more user-selectable options in the graphical user-interface.

In an embodiment of the control software, the mobile electronic communication device comprises a navigational aid configured for determining a geographic location of the mobile electronic communication device. The control software comprises ninth instructions for generating geographical data representative of the geographic location of the mobile electronic communication device; and tenth instructions for generating the input data comprising the geographical data.

The invention has been illustrated above with reference to a plurality of embodiments. It is remarked here that the characterizing features of different embodiments can be combined into yet other embodiments of the invention. For example, another embodiment of a method in the invention comprises transmitting the respective output data for each respective one of the users to a uniform pre-determined address on the data network, as well as transmitting, to a specific one of the multiple mobile electronic communication devices of a specific one of the users, the respective output data, generated from the respective input data received from the respective multiple mobile electronic communication device of each respective other one of the users.

### BRIEF DESCRIPTION OF THE DRAWING

The invention is explained in further detail, by way of example and with reference to the accompanying drawing, wherein:

FIG. 1 is a block diagram of a system in the invention; and

FIG. 2 is a diagram of a process in the invention.

Throughout the Figures, similar or corresponding features are indicated by same reference numerals.

### DETAILED EMBODIMENTS

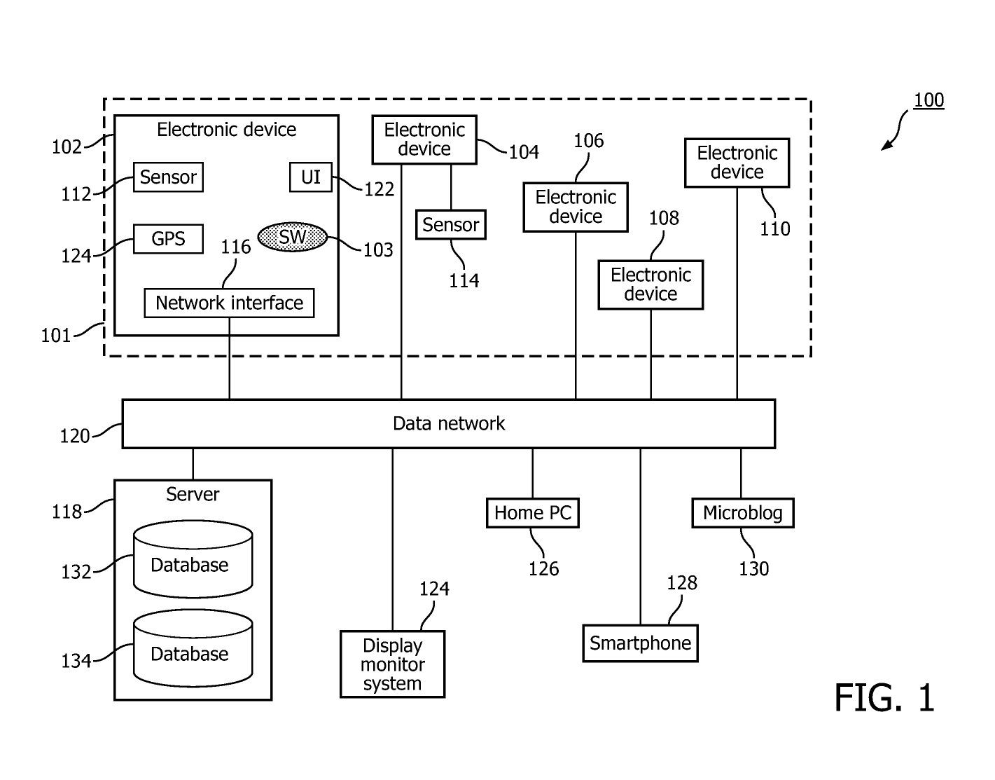

FIG. 1 is a block diagram of a system 100 according to the invention. The system 100 comprises a plurality of mobile electronic communication devices 101, such as a first mobile electronic communication device 102, a second mobile electronic communication device 104, a third mobile electronic communication device 106, a fourth mobile electronic communication device 108, and a fifth mobile electronic communication device 110.

The first mobile electronic communication device 102 comprises a first sensor 112. The first sensor 112 is configured for sensing a first value of a physiological parameter. The first value of the physiological parameter is indicative of a physiological state of the user of the first mobile electronic communication device 102. The user of the first mobile electronic communication device 102 will be referred to in the remainder of the text as the “first user”. The first sensor 112 may be configured for sensing the values of two or more different physiological parameters. That is, the first sensor 112 may be configured for sensing a first value of a first physiological parameter, and another value of another physiological parameter, different from the first physiological parameter. The first value of the physiological parameter and the other value of the other physiological parameter together are then indicative of a physiological state of the first user.

The first mobile electronic communication device 102 is shown in FIG. 1 as accommodating the first sensor 112. The second mobile electronic communication device 104 is shown in FIG. 1 as being connected to a second sensor 114 external to the second mobile electronic communication device 104. The second sensor 114 is configured for sensing a second value of a physiological parameter that may, but need not, be the same type of physiological parameter as sensed by the first sensor 112. For example, the first sensor 112 is configured for sensing the heart rate or pulse rate of the first user, whereas the second sensor 114 is configured for sensing the galvanic skin response of the second user.

Each respective one of the third mobile electronic communication device 106, the fourth mobile electronic communication device 108, and the fifth mobile electronic communication device 110 comprises, i.e., accommodates or is connected to, a respective sensor (not shown). The respective sensor is configured for sensing a respective value of a respective physiological parameter. The respective value of the physiological parameter is indicative of a physiological state of the user of the respective one of the second mobile electronic communication device 104 (i.e., the “second user”), of the third mobile electronic communication device 106 (i.e., the “third user”), of the fourth mobile electronic communication device 108 (i.e., the “fourth user”, and of the fifth mobile electronic communication device 110 (i.e., the “fifth user”).

The first mobile electronic communication device 102 further comprises a first network-interface 116 so as to be capable of data communication with a server 118 via a data network 120. Similarly, each respective one of the second mobile electronic communication device 104, the third mobile electronic communication device 106, the fourth mobile electronic communication device 108, and the fifth mobile electronic communication device 110 comprises a respective network-interface (not shown) for data communication with the server 118 via the data network 120.

The server 118 is operative to receive first input data from the first mobile electronic communication device 102, second input data from the second mobile electronic communication device 104, third input data from the third mobile electronic communication device 106, fourth input data from the fourth mobile electronic communication device 108, and fifth input data from the fifth mobile electronic communication device 110. The first input data comprises first physiological data representative of the first value of the physiological parameter sensed by the first sensor 114 of the first mobile electronic communication device. The second input data comprises second physiological data representative of the second value of the physiological parameter sensed by the sensor accommodated at the second mobile electronic communication device 104. The third input data comprises third physiological data representative of the third value of the physiological parameter as sensed by the sensor accommodated at the third mobile electronic communication device 106, and so on.

Any of the plurality 101 of mobile electronic communication devices may comprise, e.g., a mobile telephone, a Smartphone or a network-enabled palmtop PC, functionally connected to a component that accommodates the relevant sensor that is worn on, or is positioned close to, the body of the relevant user. The connection may be a wired connection or a wireless connection. The mobile telephone, the Smartphone and the network-enabled palmtop PC are examples of a generic mobile electronic communication device. Such a generic mobile electronic communication device is configured for operating in accordance with the invention by means of installing dedicated control software 103 as described earlier above. Alternatively, any of the plurality 101 of mobile electronic communication devices is designed as a dedicated network-enabled biosensor system of which the relevant sensor is a functional component.

The server 118 is further operative to process the respective input data received from the respective one of the plurality of mobile electronic communication devices 101 in order to determine a respective emotional state of the respective user of the respective mobile electronic communication device. That is, the server 118 processes the first input data for determining a first emotional state of the first user, the second input data for determining a second emotional state of the second user, the third input data for determining a third emotional state of the third user, and so on.

The determining of the respective emotional state of a specific user may be based solely on the physiological data as received from the mobile electronic communication device of this specific user. That is, the server 118 may be configured for mapping the physiological data on one of multiple pre-determined emotional states according to a pre-determined algorithm. Alternatively, the server 118 is configured for mapping a combination of the physiological data, received most recently, and one or more physiological data received on previous occasions, on one of multiple pre-determined emotional states according to a pre-determined algorithm. Alternatively, or in addition, the determining of the emotional state of the specific user is based on the physiological data, in combination with annotation data that is generated in response to a user-input from the specific user into the mobile electronic communication device of this specific user.

For example, the first mobile electronic communication device 102 comprises a user-interface 122 via which the first user can enter an annotation about his/her physiological state into the first mobile electronic communication device. The annotation is representative of the user's current emotional state. For example, the annotation describes or otherwise represents the user's current emotional state or is indicative of a valence of the user's current emotional state. The concept “valence” has been discussed earlier. In an implementation, the user-interface 122 of the first mobile electronic communication device 102 enables the first user to select a specific one of a variety of pre-determined menu options representative of a specific valence, or representative of a specific emotion having a pre-determined valence. The user-interface 122 comprises, for example, a pre-configured set of hard-buttons with user-legible indications, a slider or a rotary dial together with a scale with user-legible indications, or a graphical user-interface with soft-keys in a menu, a speech-recognition component, etc.

Accordingly, the first user enters the annotation into the first mobile electronic communication device 102, by way of indicating in the user-interface 122 the currently applicable valence and/or his/her currently applicable emotional state. In response to the first user entering the annotation, the mobile electronic communication device 102 generates first annotation data that is sent to the server 118 as part of the first input data.

What has been specified above for the first mobile electronic communication device 102 and with respect to the concept “annotation” applies, mutatis mutandis, to each respective other one of the plurality of mobile electronic communication devices 101. For example, the emotion of the second user of the second mobile electronic communication device 104 may be determined from the physiological data, derived from the value of the physiological parameter as sensed by the sensor at the second mobile electronic communication device 104, or the second mobile electronic communication device 104 comprises a further user-interface (not shown) for letting the second user enter into the second mobile electronic communication device 104 an annotation about his/her physiological state representative of the second user's current emotional state. The second mobile electronic communication device 104 generates annotation data and is sent to the server 118 as part of the second input data.

Accordingly, the server 118 receives respective input data from each respective one of the plurality of mobile electronic communication devices 101 and processes the respective input data for determining a respective emotional state of the respective user.

The server 118 is also operative to determine a respective geographical location of each respective one of the plurality of mobile electronic communication devices 101 and, therefore, of each respective user.

For example, the first mobile electronic communication device 102 includes a GPS receiver 124 for generating first geographical data representative of the current first geographical location of the first mobile electronic communication device 102 and sends the first geographical data to the server 118 as part of the first input data.

As another example, the second mobile electronic communication device 104 has a user-interface (not shown) via which the second user can enter information into the second mobile electronic communication device 104 about his/her current geographical location. The second mobile electronic communication device 104 is configured for generating second geographical data representative of the geographical location of the second user, and sends the second geographical data to the server 118 as part of the second input data.

As yet another example, the system 100 comprises a monitoring system (not shown) configured for monitoring the users of the plurality of mobile electronic communication devices 101 while the users are present within a specific geographical area that is covered by the monitoring system. The monitoring system comprises, e.g., a camera system covering a specific geographical area such as a music hall, a municipal park, a city square, or another geographical area at which a certain event is taking place that is attended by these users.

Accordingly, the server 118 processes the respective input data received from each respective one of the plurality of mobile electronic communication devices 101, and produces respective output data. The respective output data is representative of the respective emotional state of the respective user as well as of the respective geographical location of the respective one of the plurality of mobile electronic communication devices 101 and, therefore, of the respective user.

Consider a first application scenario, wherein the users of the plurality of mobile electronic communication devices 101 are attending a group-event or a public event that is being held in a specific geographical area. Examples of such event are, e.g., a football match, a music festival, the bi-annual International Autojumble at Beaulieu (UK), a dance festival, a concert, an art auction, a protest march, a political gathering, a village barbecue or another social gathering, a conference, the Consumer Electronics Show (CES) held each year in Las Vegas, etc, etc. The server 118 transmits the respective output data, produced from the respective input data, as received from the respective one of the plurality of mobile electronic communication devices 101, to a display monitor system 124, local to the specific geographical area and connected to the data network 120. The display monitor system 124 comprises one or more display monitors (not shown), accessible to each of the users of the plurality of mobile electronic communication devices 101, or accessible to all people attending the group-event or the public event. The display monitor system 122 receives the respective output data from the server 118 and generates respective graphical representations on the one or more display monitors under control of the respective output data. Each respective graphical representation is indicative of the respective emotional state of the respective user of the respective one of the plurality of mobile electronic communication devices 101, as well as of the respective geographical location of the respective user within the specific geographical area. For example, a respective position of a respective graphical representation on a display monitor's screen is indicative of the respective geographical location of the respective user within the specific geographical area, and a respective graphical attribute of the respective graphical representation (e.g., a color, shading, a shape or symbol) is indicative of the respective user's emotional state. Assuming that people at the event respond emotionally in similar ways to a particular type of stimulus from their common environment (here: the event), the display monitor system 122 provides information to the attendants of the event about which sections of the geographical area are triggering what kind of emotions which, in turn, may serve as a guide to avoid certain sections or to go visit certain other sections.

Consider a second application scenario, wherein the users of the plurality of mobile electronic communication devices 101 are attending a group-event or a public event that is being held in a specific geographical area. The server 118 receives the respective input data, and processes the respective input data to produce the respective output data. Each respective output data is representative of the current emotional state and the current geographical location of a respective one of the users. Each particular one of the users has specified in advance that the particular output data, generated on the basis of the particular input data submitted by his/her mobile electronic communication device, be transmitted to one or more particular addresses on the data network 120. For example, the first user of the first mobile electronic communication device 102 has specified in advance that the first output data, generated on the basis of the first input data as received by the server 118 from the first mobile electronic communication device 102, be transmitted to his/her network-enabled personal computer (PC) 126 at home, and to a Smartphone 128 of a friend. The second user of the second mobile electronic communication device 104 has specified in advance that the second output data, generated on the basis of the second input data received by the server 118 from the second mobile electronic communication device 104, be transmitted to another server 130 of a microblogging service. The third user of the third mobile electronic communication device 106 has specified in advance that the third output data, generated on the basis of the third input data as received by the server 118 from the third mobile electronic communication device 106, be transmitted to the first mobile electronic communication device 102 and to the fourth mobile electronic communication device 108. The first user, the third user and the fourth user happen to be friends attending the public event. The first mobile electronic communication device 102 and the fourth mobile electronic communication device 108 are configured for receiving data via the data network 120 and for rendering the received data on a respective display monitor accommodated at the respective one of the first mobile electronic communication device 102 and the fourth mobile electronic communication device 108. In above second application scenario, a particular one of the users of the plurality of mobile electronic communication devices 101 keeps one or more other individuals informed about his/her emotional state while attending the event.

In order for the server 118 to be able to selectively send the specific output data, generated from the specific input data as received from a specific one of the plurality of mobile electronic communication devices 101, to one or more particular destinations on the data network 120, the server 118 comprises a database 132. The database 132 stores for each respective one of the first user, the second user, the third user, the fourth user and the fifth user, respective destination data representative of the one or more respective destinations as specified by the respective user in advance.

Consider a third application scenario, wherein the server 118 comprises another database 134 that stores for each specific one of the users a specific user-profile, e.g., based on declared preferences, demographic information, etc. The server 118 transmits to, for example, the first mobile electronic communication device 102, the respective output data, generated from the respective input data submitted by each respective other one of the mobile electronic communication devices 101, whose respective user has a respective user-profile that matches the user-profile of the first user. That is, the first mobile electronic communication device 102 of the first user receives from the server 118 the output data that is representative of the emotion and geographic location of any of the other users, whose user-profile matches the user-profile of the first user. The first user can then determine where within the geographical area there are like-minded people. Alternatively, or in addition, the server 118 sends to the first mobile electronic communication device 102 a recommendation regarding which geographic section of the geographic area is currently likely to contain like-minded people based on the clustering of the emotions of people with a similar user-profile.

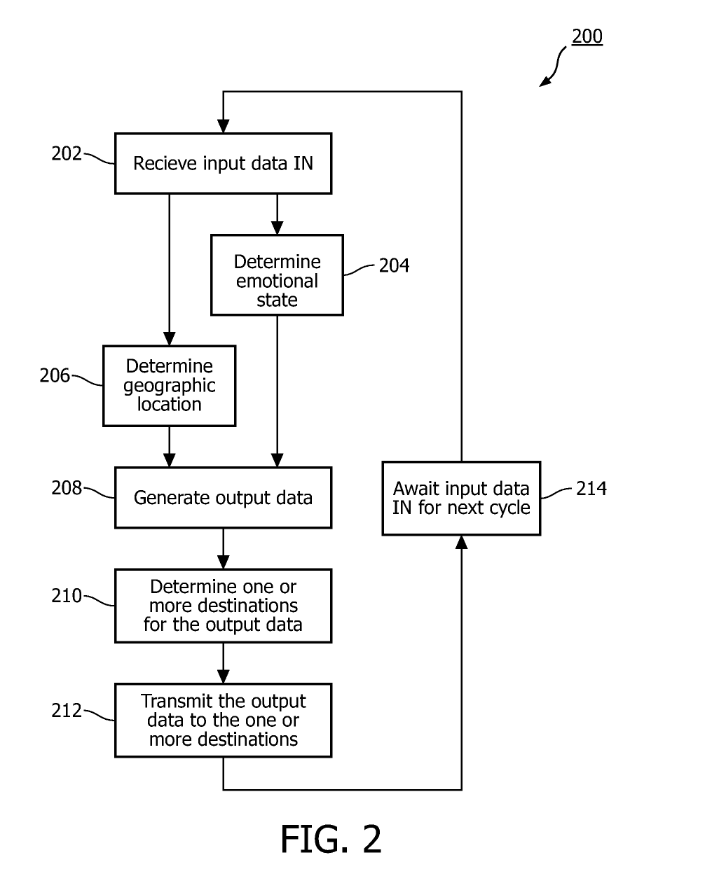

FIG. 2 is a diagram of a process 200 according to the invention. The process 200 illustrates the processing of data as applicable to each individual one of the plurality 101 of mobile electronic communication devices.

In a first step 202 of the process 200, input data is currently received from the specific mobile electronic communication device, e.g., the first mobile electronic communication device 102.

In a second step 204, the current emotional state is determined of the user of the specific mobile electronic communication device, based on the current input data received in the first step 202. The input data comprises physiological data representative of one or more values of a single physiological parameter as sensed by a biosensor. The physiological data may also be representative of multiple sets, each specific one of the sets comprising one or more values of a specific one of multiple physiological parameters. As specified earlier, the valence of the current emotion cannot reliably be inferred from the current values of the one or more physiological parameters. Accordingly, the input data also includes annotation data representative of the annotation intentionally entered by the user into the specific mobile electronic communication device via the device's user-interface. The annotation is then interpreted as a subjective comment from the user about his/her emotional state. The current emotional state of the user is then inferred from the combination of the current physiological data and the current annotation data.

In a third step 206, the current geographic location is determined of the user of the specific mobile electronic communication device. The current geographic location of the user can be determined in a variety of manners. For example, the user is tracked using computer-controlled identification and a CCTV monitoring system. As another example, the user is given an RF-beacon, whose geographic location is determined via external detectors. For example, the beacon transmits signals that are received by one or more detectors. The strength of the signal received per beacon can then be used to determine the location of the beacon based on, e.g., proximity to one or more beacons, or through triangulation. As another example, the user is given an RF-tag, whose geographic location is determined via one or more external detectors that interact with the RF-tag whenever the user passes a detector within close range. As yet another example, the user carries along with him/her the specific mobile electronic communication device. The current geographic location of the user equals, for all practical purposes of the invention, the current geographic location of the specific mobile electronic communication device. The current geographic location of the user can then be determined, e.g., from geographic data received as part of the input data. The geographic data may have been generated by a navigational aid accommodated at the specific mobile electronic communication device. Alternatively, the user may have entered an annotation into the specific mobile electronic communication device that is indicative of his/her whereabouts. Alternatively, the current geographic location of the user is determined from the strength of the signal from the specific mobile electronic communication device that carries the input data and/or from triangulation.

The second step 204 and the third step 206 may be carried out one after the other in this order or in reverse order, or the second step 204 and the third step 206 may be carried out independently of one another, e.g., substantially simultaneously.

In a fourth step 208, the output data is generated under combined control of the current emotional state, as determined in the second step 204, and of the current geographical location, as determined in the third step 206. The current output data is therefore representative of the current emotional state as well as the current geographical location of the user. This output data can then be used, e.g., to represent the user symbolically on the screen of a display monitor, or can be sent to a history log that may serve as a diary of this user, giving the emotional state and geographical location at various moments of the day.

In a fifth step 210, it is determined to which destination or to which destinations on the data network 120 the current output data for this user is to be transmitted. The one or more destinations may have been determined in advance. The one or more pre-determined destinations may depend on the current emotional state and/or on the current geographical location. For example, the user of the specific mobile electronic communication device has specified in advance that the output data be transmitted to a certain destination only if the valence of the emotional state is positive. Alternatively, or in addition, the user may have specified that the output data be transmitted to other mobile electronic communication devices whose users have a user-profile matching the user-profile of the user of the specific mobile electronic communication device.

In a sixth step 212, the current output data is transmitted via the data network 120 to the one or more destinations determined in the fifth step 210.

After the sixth step 212, the process 200 enters a seventh step 214.

In the seventh step 214, the process 200 waits until the start of a next processing cycle, wherein the process 200 returns to the first step 202. The next processing cycle starts when the next, then current, input data is received from the specific mobile electronic communication device in the first step 202 of the next cycle.

1. A method of providing a service on a data network, wherein:
the method comprises receiving via the data network respective input data from a respective one of multiple mobile electronic communication devices of a respective one of multiple users;
each respective mobile electronic communication device comprises a respective sensor; and a respective user-interface;
the respective sensor is configured for sensing a respective value of a respective physiological parameter indicative of a respective physiological state of the respective user;
the respective user-interface is configured for letting the respective user enter into the respective mobile electronic communication device a respective annotation about the respective physiological state;
the respective input data comprises:
respective physiological data representative of the respective value of the respective physiological parameter; and
respective annotation data representative of the respective annotation;
the method further comprises:
processing the respective input data for determining a respective emotional state of the respective user;
determining a respective geographical location of the respective mobile electronic communication device;
generating respective output data under combined control of the respective emotional state and of the respective geographical location; transmitting the respective output data for each respective one of the users to a uniform pre-determined address of a display monitor system on the data network.

2. (canceled)

3. The method of claim 1, comprising transmitting, to a specific one of the multiple mobile electronic communication devices of a specific one of the users, the respective output data, generated from the respective input data received from the respective multiple mobile electronic communication device of each respective other one of the users.

4. The method of claim 1, comprising:
for each specific one of the multiple users determining a specific user-profile; and
transmitting, to a specific one of the multiple mobile electronic communication devices of a specific one of the users, the respective output data, generated from the respective input data received from the respective multiple mobile electronic communication device of each respective other one of the users, who has a respective user-profile matching the specific user-profile.

5. The method of claim 1, comprising:
enabling a particular one of the users to specify in advance one or more particular destination addresses on the data network;
determining whether or not the particular user has specified the one or more particular destination addresses; and
only if the particular user has specified in advance the one or more particular destination addresses, sending the output data, generated under combined control of the emotional state of the particular user and of the geographical location of the particular user, to the one or more particular destination addresses.

6. The method of claim 5, wherein the particular user has specified in advance as the particular destination address a specific address on the data network of a specific one of the multiple mobile electronic communication devices.

7. The method of claim 1, comprising processing the respective output data only if the respective emotional state complies with a pre-determined criterion.

8. The method of claim 1, wherein:
the respective mobile electronic communication device comprises a respective navigational aid for determining the respective geographical location of the respective mobile electronic communication device; and
the respective input data comprises respective geographical data representative of the respective geographic location.

9. A mobile electronic communication device comprising a network-interface, a user-interface, and a sensor-interface, wherein:
the network-interface is configured for data communication between the mobile electronic communication device and a data network;
the sensor-interface is configured for receiving a signal from a sensor that is operative to sense a value of a physiological parameter indicative of a physiological state of a user of the mobile electronic communication device;
the user-interface is configured for letting the user enter an annotation about the physiological state into the mobile electronic communication device;
the mobile electronic communication device is configured for communicating input data to a pre-determined address of a display monitor system on the data network;
the input data comprises physiological data representative of the value of the respective physiological parameter, and annotation data representative of the annotation;
further comprising a navigational aid configured for determining a geographic location of the mobile electronic communication device; and
the input data comprises geographical data representative of the geographic location of the mobile electronic communication device.

10. The mobile electronic communication device of claim 9, configured for automatically uploading the physiological data as input data to the pre-determined address on the data network upon the mobile electronic communication device detecting a change in the physiological state of the user.

11. The mobile electronic communication device of claim 9, wherein:
the user-interface comprises a graphical user-interface for presenting a menu of one or more pre-determined user-selectable options;
each specific one of the one or more pre-determined user-selectable options is indicative of a specific one of one or more possible emotional states of the user;
the user-interface enables the user to enter the annotation about the physiological state into the mobile electronic communication device by means of the user selecting a particular one of the one or more user-selectable options in the graphical user-interface.

12. (canceled)

13. Control software for enabling carrying out a method according to claim 1, the control software being stored on a computer-readable medium and configured for being installed on a mobile electronic communication device with a network-interface, a sensor-interface and a user-interface, wherein:
the network-interface is configured for data communication between the mobile electronic communication device and a data network;
the sensor-interface is configured for receiving a sensor signal from a sensor, the sensor being operative to sense a value of a physiological parameter indicative of a physiological state of a user of the mobile electronic communication device; and
the user-interface is configured for enabling the user to interact with the mobile electronic communication device;
the control software comprises:
first instructions for processing the sensor signal for generating physiological data representative of the value of the physiological parameter;
second instructions for receiving from the user-interface annotation data that is representative of an annotation entered by the user into the mobile electronic communication device via the user-interface;
third instructions for generating input data that comprises the physiological data and the annotation data;
fourth instructions for transmitting the input data via the data network to one or more pre-determined destinations on the data network.

14. The control software of claim 13, wherein:
the control software comprises fifth instructions for detecting a change in the physiological state of the user; and
the fourth instructions comprise sixth instructions for automatically uploading the physiological data in the input data to the pre-determined address on the data network upon the detected change in the physiological state of the user.

15. The control software of claim 13 wherein:
the user-interface comprises a graphical user-interface;
the control software comprises seventh instructions for presenting a menu of one or more pre-determined user-selectable options;
each specific one of the one or more pre-determined user-selectable options is indicative of a specific one of one or more possible emotional states of the user;
the control software comprises eighth instructions for generating the annotation data in response to the user selecting a particular one of the one or more user-selectable options in the graphical user-interface.

16. The control software of claim 13, wherein:
the mobile electronic communication device comprises a navigational aid configured for determining a geographic location of the mobile electronic communication device;
the control software comprises:
ninth instructions for generating geographical data representative of the geographic location of the mobile electronic communication device;
tenth instructions for generating the input data comprising the geographical data.
